(19) United States
(12) Patent Application Publication
(10) Pub. No.: US 2006/0156655 A1
(43) Pub. Date: Jul. 20, 2006

(54) System and method for fabricating an aperture in a structure

(76) Inventor: John L. Rizzotto SR., Stuart, FL (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/320,806

(22) Filed: Dec. 30, 2005

Related U.S. Application Data
(60) Provisional application No. 60/640,224, filed on Jan. 3, 2005.

(51) Int. Cl. E06B 1/04

(52) U.S. Cl. 52/215

(57) ABSTRACT

Frames can be fashioned from metal bent at right angles to accommodate standard window or door. For example, an 8-¾″ flat strip metal, having at least three right angle breaks, forms a buck. Alternatively, a slip-over buck has a first pair of walls substantially parallel to one another which are used to affix the buck to the structure. A second pair of walls substantially parallel to the first two walls rises above the first pair of walls. The second pair of walls is joined at the tops with a perpendicular wall. This perpendicular wall is used as the frame mount. The window or door is attached to the buck as per the manufacturer's specifications. The buck provides the builder with the ability to frame an exact margin for a window or door, improves finishing interior and exterior facades, and provides a better seal against water infiltration and drafts.

This application claims priority to U.S. provisional application 60/640,224 filed Jan. 3, 2005, the entirety of which is incorporated herein by reference.

### FIELD OF THE INVENTION

The present invention relates to steel frame buildings and more precisely to a metal member that acts as a door or window buck.

### BACKGROUND OF THE INVENTION

Steel framing is used for rapid, low-cost building assembly. While it is known to construct steel frame buildings where the frame connects between the foundation and roof beams, there is no convenient mechanism for creating door and window bucks. U.S. Patent Publication No. US 2002/0148188, incorporated herein by reference, discloses a system for assembling a steel frame building.

FIG. 1 is an exploded view showing a main column 5 used in the assembly of a steel building along with a gutter 2, a truss assembly 4 and a foundation assembly 6. Only a portion of the truss is shown in this Figure. This portion is made up of a left truss connection plate 4C, a lower chord 4A, a top member of the truss 4B, and an attachment plate 4C. At the top of this drawing is an adjustable rain gutter 2 with a support arm 2A, which contains a series of evenly spaced holes 2B. Directly beneath the support arm 2A, is a structural adjustment sleeve 3 which includes a line of vertically positioned evenly spaced holes 3A.

Directly beneath the structural adjustment sleeve 3 is the column 5, which contains holes at its top 5A and holes at its bottom 5B. Directly beneath the column 5 is the foundation assembly 6, which includes a low column 6D, a series of vertical holes 6A in the low column 6D, a horizontal plate 6B which is attached approximately midway up from the bottom of the low column and stabilizing tubes 6C which extend horizontally and are attached to the bottom of the low column.

The column assembly is shown completely assembled in FIG. 2. In this Figure, the support arm 2A for the gutter 2 is placed into the top of the structural adjustment sleeve 3. The bottom end of the structural adjustment sleeve is placed over the column 5. The truss connection plate 4C is U-shaped and wraps around to enclose a portion of the structural adjustment sleeve. The column 5 is hollow and is placed over the low column of the foundation assembly 6.

All the components shown in FIGS. 1 and 2 are bolted together. There is no need to weld any component, facilitating assembly on the job site. In addition, where height adjustment is required, it is provided by series of vertical holes. For example, the truss assembly can be moved up or down along the structural adjustment sleeve to a desired height and then locked at that height by placing a bolt through the truss connection plate 4C into one of the holes in the structural adjustment sleeve 3 that is at a desired level. A similar assembly and adjustment is carried out for the gutter. The gutter arm which supports the gutter contains a series of vertical holes 2B, which can be aligned with the holes 3A in the structural adjustment sleeve. The gutter is moved up or down to a desired location and a bolt is placed through the structural adjustment sleeve holes and the holes in the support arm for the gutter to lock the gutter in a desired location.

The foundation assembly 6 is set in concrete before any assembly begins. The plate 6B, which extends out horizontally from the low column portion of the foundation assembly lies on the top of the concrete and sets the depth to which the foundation assembly is placed in the concrete. It is accurately positioned in the vertical plane to set the elevation of the main column which will rest on this plate. Of equal importance is the fact that this plate is set to lie in the horizontal plane which insures that the orthogonally positioned low column is perfectly vertical and will support the main column in a perfectly vertical position. The foundation assembly is precisely located with respect to the various other main columns so that when a main column is placed over a low column of the foundation assembly, it is accurately located, enabling the components of the building to be assembled without cutting or drilling on site.

The precise location of the foundation assemblies is typically carried out with a laser interferometer which is vastly more accurate than the usual steel tape measure method used at most prior art construction sites. In addition, a laser leveling device is used to insure that the top surface of all the foundation plates are at precisely the same elevation, often within an error allowance as small as +/−0.001 inch. The present invention insures that the columns are precisely located in the both the horizontal and vertical planes, which means that they are at the correct elevation and are plumb and square.

The stabilizing tubes, which are connected to the bottom of the foundation assemblies, are horizontally positioned rods. They anchor the foundation assemblies to the concrete footing and aid in preventing the foundation assemblies from being pulled from the concrete by uplift loads. A second anchoring system, which employs a “chair” to provide even greater uplift load capacity, is described later in this section.

The short column 6D of the foundation assembly is typically rectangular in cross section as is the main column. Where the main column is hollow, the low column is typically made to be slightly smaller in cross sectional than the main column so that the low column fits inside the base of the main column. Where the main column is solid, a collar is substituted for the low column. The collar grips the main column from the outside, making it possible to use solid or closed ended columns for this type of construction.

In the assembly of the trusses and hollow columns, each column is placed over the foundation assembly and locked into place by placing bolts through holes 5B in the main column and 6A in the low column portion of the foundation assembly. This method of positioning the foundation assembly and the method of connection between the column and the foundation assembly provide a substantial advantage in assembly over the prior art. This method is simple and fast, while at the same time insuring the accurate location and positioning of the columns in both the horizontal and vertical planes.

The rest of the building may then be finished as desired by the builder. For example, in a preferred embodiment, an overhang for the roof is formed by inserting 1 inch by 3 inch steel tubing into the open ends of the trusses 460, cut to the proper pitch and adjusted to the proper length to create the desired overhang, and then connecting them together around the perimeter of the roof using a steel sub-fascia. A fascia and insulation may then be applied. This greatly improves the insulation qualities of the resulting building, reducing heating and cooling costs.

It is important to remember that houses constructed with steel frames can still contain fair amounts of wood: floors, roof panels, joists, stairs, carpet anchors, decorative pillars, lanai pillars, eaves, railings, window frames, doors, and door jambs. In the prior art, pressure treated lumber is used to frame the window and door openings.

Window or door bucks are typically wooden frames that provide the rough opening and structure into which doors or windows are installed. Conventional houses built of lumber or steel use the same dimensional lumber for these openings as is used in the rest of the wall. Bucks may be made of ¾″ plywood, and may vary from 12″ in width (thus being half the thickness of a 24″ wall) up to the entire thickness of the wall. Bucks are often constructed to be less than the thickness of the wall.

However, lumber is not as durable as steel and greatly reduces the insulating properties of the building. What is needed is a door and window buck that maximizes the steel construction structure.

### SUMMARY OF THE INVENTION

The present invention provides a buck assembly system for a building that substantially reduces the assembly time while maintaining excellent strength and mechanical integrity. The present buck assembly system can be fashioned from 20 gauge metal. The buck is used to install aperture closures such as doors, windows, and the like.

In a preferred embodiment, a buck assembly is formed so that a first mounting tab can be affixed to the outside of a structure. The buck includes a raised portion that is substantially u-shaped for mounting a window frame. A second mounting tab is connected to the raised portion through at least one bend of approximately 90°.

In another embodiment, a slip-over buck has a first pair of walls substantially parallel to one another which are used to affix the buck to a structure. A second pair of walls substantially parallel to the first two walls rises above the first pair of walls. The second pair of walls is joined at the tops with a perpendicular wall. This perpendicular wall is used as the frame mount. The second pair of parallel wall can be offset from the first pair of parallel walls.

In one embodiment, the buck is affixed to the outer surfaces of a wall. The buck includes a raised portion to which the window frame is mounted. In one embodiment, the portion of the buck that mounts to the structure is generally u-shaped without a separate raised window frame mounting portion. The disclosed buck provides load strength far in excess of building requirements.

Window or door frames can be fashioned from 20 gauge metal. In a preferred embodiment, such metal is bent at substantially right angles to accommodate standard window or door sizes and attachment to wall panels 440, thereby creating metal frame openings. For example, with an 8-¾″ flat strip of 20 gauge metal, a right angle breaks of 2-¾″, 4-½″, ¾″ and ¾″ form a buck as shown in FIG. 22. Bucks are attached using the 2-¾″ and ¾″ edges to the sides of an opening in the wall with #8×½″ wafer head screws, fastened to the wall studs that form the sill. The window or door is then attached to the buck as per the manufacturer's specifications. Preferably, the manufacturer's recommended fasteners penetrate the buck and the rough opening with a single fastener, thereby increasing the shear strength of the connection. The buck provides the builder with the ability to frame an exact margin for a window or door, improves finishing interior and exterior facades, and provides a better seal against water infiltration and drafts.

In a preferred embodiment, the buck components are bent at right angles to accommodate standard window or door sizes and attachment to wall panels to create metal frame openings.

In a another embodiment, an 8-¾″ flat strip of 20 gauge metal, having substantially right angle breaks of 2-¾″, 4-½″, ¾″ and ¾″ form a buck that is attached using the 2-¾″ and ¾″ edges to the sides of an opening in a wall panel. The window or door is then attached to the buck as per the manufacturer's specifications.

In use, the window manufacturer's recommended fasteners penetrate the buck and secure the window in the rough opening with a single fastener. The buck provides the builder with the ability to frame an exact margin for a window or door, improves finishing interior and exterior facades, and provides a better seal against water infiltration and drafts.

In one embodiment, a frame for an aperture in a building comprises:

an elongated sheet of material;

the sheet having 4 breaks of substantially 90 degrees,

the first break forming a first and second wall, the first wall extending in a first direction from an edge of the sheet to the first break and the second wall extending in a second direction;

the second break forming a third wall, the third wall being substantially parallel to the first wall extending in a third direction opposite the first direction;

the third break forming a forth wall, the forth wall extending in the first direction.

In one embodiment, the sheet of material is approximately 8.75 inches wide.

In one embodiment, the first wall is approximately 2.75 inches wide.

In one embodiment, the second wall is approximately 4.5 inches wide.

In one embodiment, the third wall is approximately 0.75 inches wide.

In one embodiment, the forth wall is approximately 0.75 inches wide.

In one embodiment, the sheet of material is approximately 20 gauge metal.

In one embodiment, the sheet of material is a vinyl extrusion material.

The disclosed bucks slip over the opening in a structure. Then, the bucks are affixed to three sides of the opening, allowing the fourth side to be loose. The window is placed in the opening and attached to the three fixed sides. After the window is attached to the three fixed bucks, the fourth buck is then attached to the window, drawing the buck to a tight or zero clearance. The fourth buck is then permanently attached to the structure. All joints are sealed with an approved sealant. The buck is then preferably covered with approved industry finishes.

The benefit of installing windows or doors with this method is that it eliminates air and water infiltration which is the food source for mold. This will eliminate some health conditions and reduce mold litigation. By creating an air tight opening there is a reduction in loss of heating and cooling thereby saving money in energy bills. Manufacturers can make one standard window type instead of two (with and without nail fins) because all construction accepts the same window allowing the maker of windows to be more profitable. Finally, installation is fast and precise allowing the builder/installer to accelerate job completion

### DESCRIPTION OF THE FIGURES

FIG. 1 is an exploded view showing a main column used in the assembly of a steel building;

FIG. 2 shows the column assembly completely assembled;

FIG. 3 is a view of a wall having a window opening;

FIG. 4 is a perspective view of a window or door buck according one embodiment of the invention;

FIG. 5 is a side view of the window or door buck according to one embodiment of the invention;

FIG. 6 is a depiction of the window buck once it is installed;

FIG. 7 is a cutaway view of the construction along the line 7-7;

FIG. 8 is a side-view of a buck for masonry applications;

FIG. 9 is a side-view of an installed buck for masonry applications;

FIG. 10 is a perspective view of a window or door buck according another embodiment of the invention;

FIG. 11 is a side-view of a buck;

FIG. 12 is a side-view of an installed buck;

FIG. 13 is a perspective view of a window or door buck according another embodiment of the invention;

FIGS. 14a-14e are each a side view of an embodiment of the buck;

FIGS. 15a-15d are each a side view of an embodiment of the buck;

FIG. 16 is a load analysis for the buck; and

FIG. 17 is a load analysis for the buck.

### DETAILED DESCRIPTION OF THE INVENTION

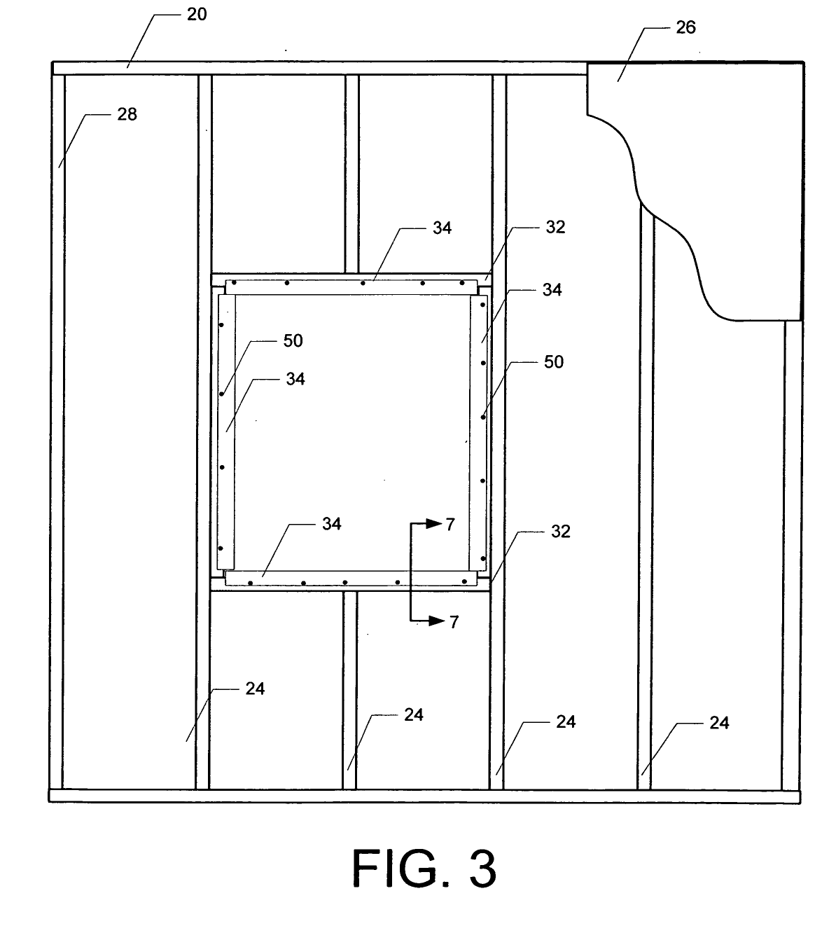

FIG. 3 depicts a wall constructed using the described window buck. As shown, the wall consists of a header 20 and footer 22. Header 20 and footer 22 have a track in which studs 24 are mounted. Additionally, as shown, at the end of each wall is column 28. Steel construction, wood frame construction, masonry construction and the like could all be used with the disclosed buck. In a preferred embodiment, wall panels 26 are used to finalize the construction of the wall. As shown, a window opening is framed using building elements 32. These elements 32 create a rough opening for a window. Once the rough opening is framed, window bucks 34, according to the present invention, are installed.

The window bucks 34 are installed around the rough opening before a window is installed in the opening. The window bucks 34 provide the final size for the window. Likewise, when the bucks 34 are used as door bucks, the door is framed and then bucks 34 are used to provide the final sizing. The doors are installed in a manner similar to the windows as detailed herein.

In one embodiment, two opposing bucks are squared and secured to the structure match a window frame. Preferably, the pair of bucks is the top and bottom buck. The other two bucks, i.e., the side bucks, are then place in the rough opening. The window frame is then attached to the bucks and the side bucks are secured to the structure. It should be noted that only one buck has to be secured to the structure before the window frame is attached to the buck.

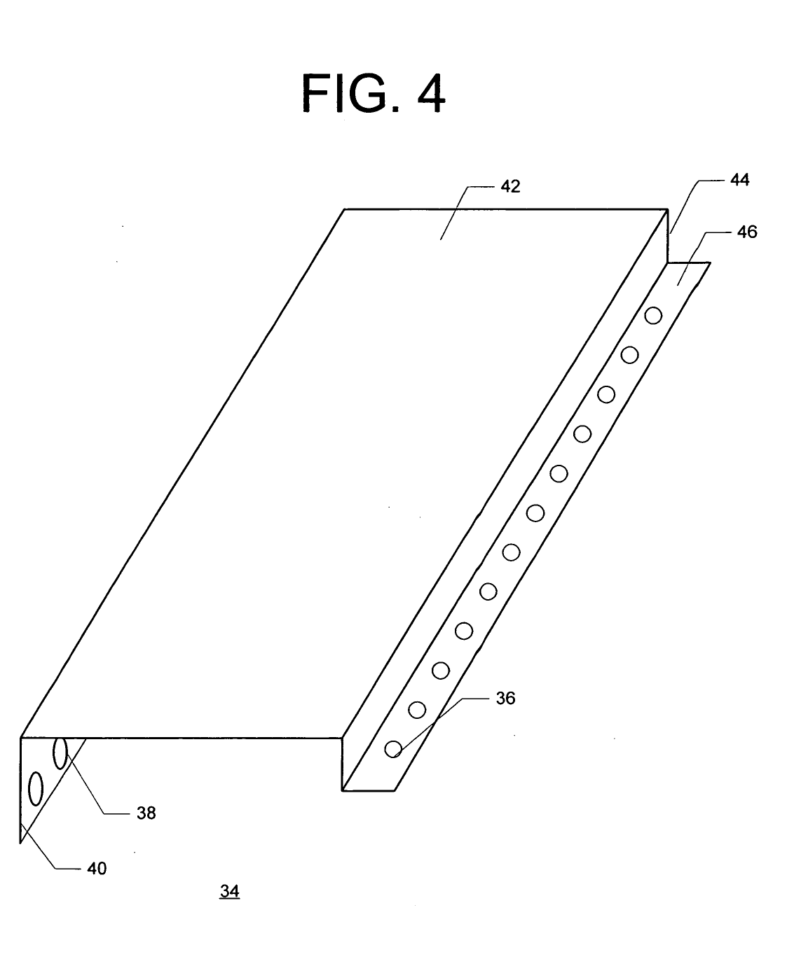

A perspective view of window buck 34 is shown in FIG. 4. Buck 34 is preferably made from 20 gauge steel. Alternatively, aluminum, other gauge steels, composite material, vinyl, plastic, PVC, or other material can be used. In a preferred embodiment, the metal is prepared so that it does not corrode. The buck 34 has a first wall 40 extending in a first direction. This first wall 40 has holes 38 that are used to mount the buck to the face of the rough framing. In one embodiment, the holes 38 used for attaching the buck to the studs 24 are substantially slots so that if any additional shimming is required, the buck 34 can be properly placed. The buck 34 has a second wall extending substantially perpendicular from one end of the first wall 40. In a preferred embodiment, this wall extends for approximately 4-½ inches. At the far end of the second wall is a third wall 44 extends substantially perpendicular to the second wall 42, and parallel to the first wall. Finally, a fourth wall 46 extends substantially perpendicular to the third wall extends away from the second and third walls. The width of the third and fourth walls is substantially ¾ of an inch. It should be noted that fourth wall 46 includes mounting holes 36 used to mount the buck in the framed window opening.

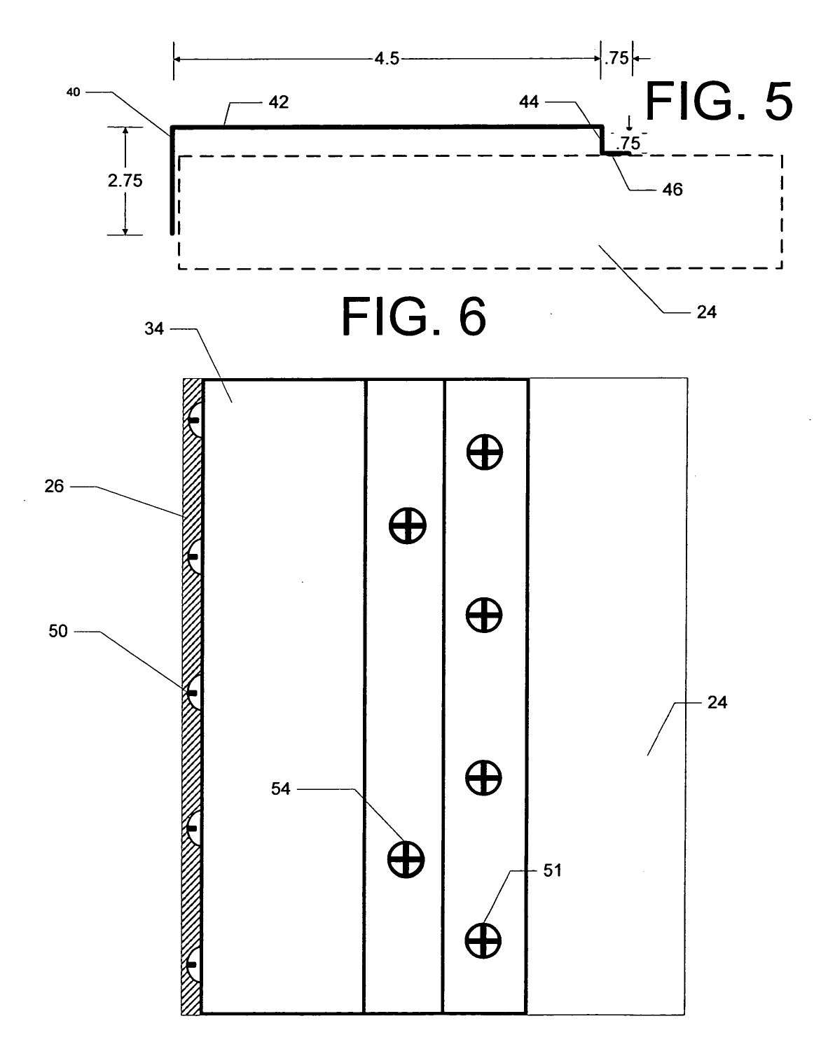

The general shape of the buck 34 is shown in FIG. 5. The disclosed buck 34 is adapted to attach to the sides of a framing member as shown by the dashed line in FIG. 5. It should be noted that the first wall 40 is substantially at 90° to the second wall 42 and that the third wall 40 is substantially parallel to first wall 40. Likewise, the fourth wall 44 is substantially parallel to the second wall 42. In a preferred embodiment, the buck 34 is manufactured using an 8¾″ flat strip of 20 gauge metal.

FIG. 6 depicts a window buck 34 as it would appear on the inside of a window opening. As shown, the window buck 34 is attached to a stud 24 using screws or nails 50, 51. In another embodiment, the attaching means are rivets, nuts and bolts, screws, nails, welds, epoxies, or the like. In a preferred embodiment, attaching means 50, 51 are #8 wafer head screws. Wall panel 26 is drywall. Once the buck 34 is fixed to the window opening, window sash 52 is affixed to the buck 34 using connecting means 54. Connector 54 is any structurally acceptable connector, manufacturing recommended connector, or those used for attachment means 50 and 51. Preferably, connector 54 is recommended by the manufacturer of the window being used.

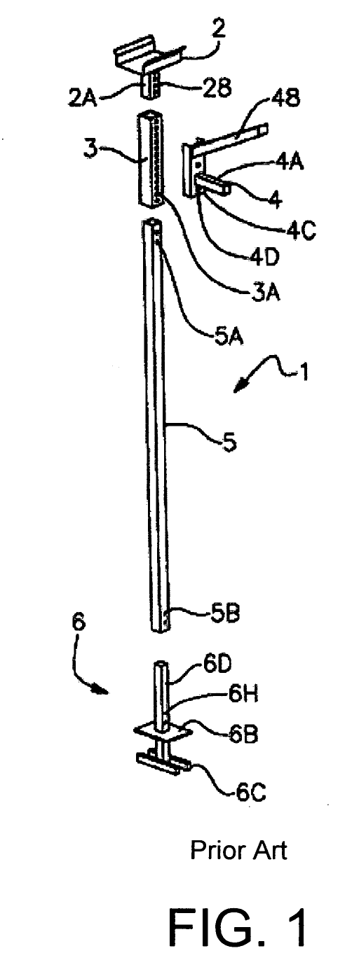

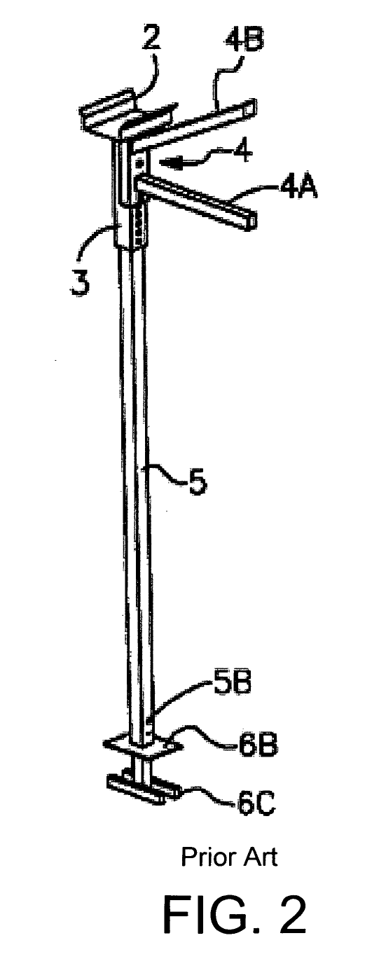

FIG. 7 depicts the cutaway view along line 7-7 in FIG. 1. As shown, the buck 34 is attached to sill 32 using connectors 50 and 51. Additionally, connector 54 affixes window frame 52 to buck 34. In a preferred embodiment, connector 54 penetrates sill 32. Alternatively, a nut holds connector 54 in place.

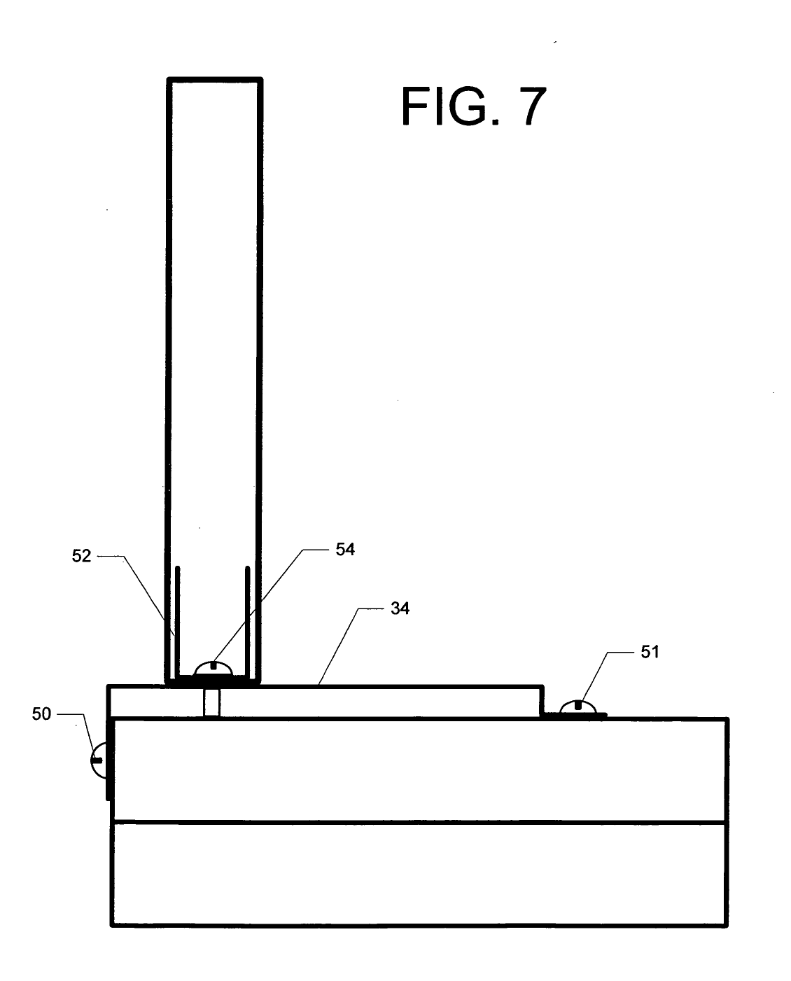

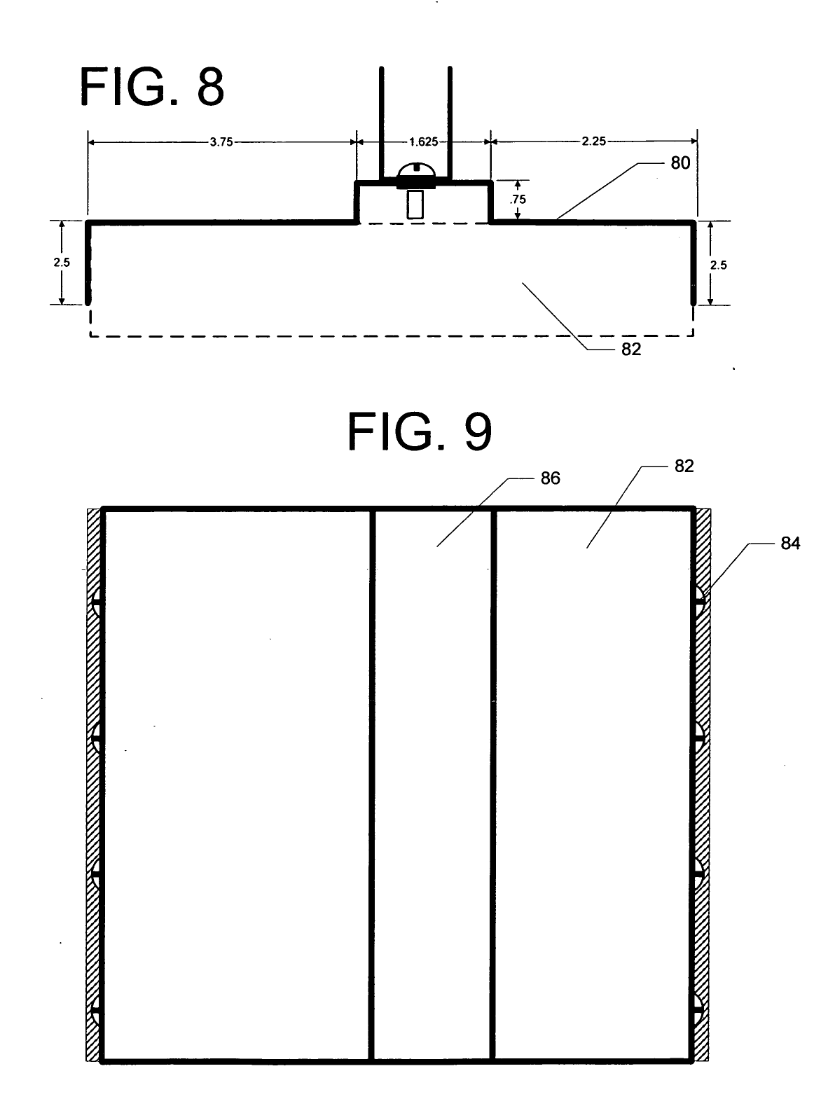

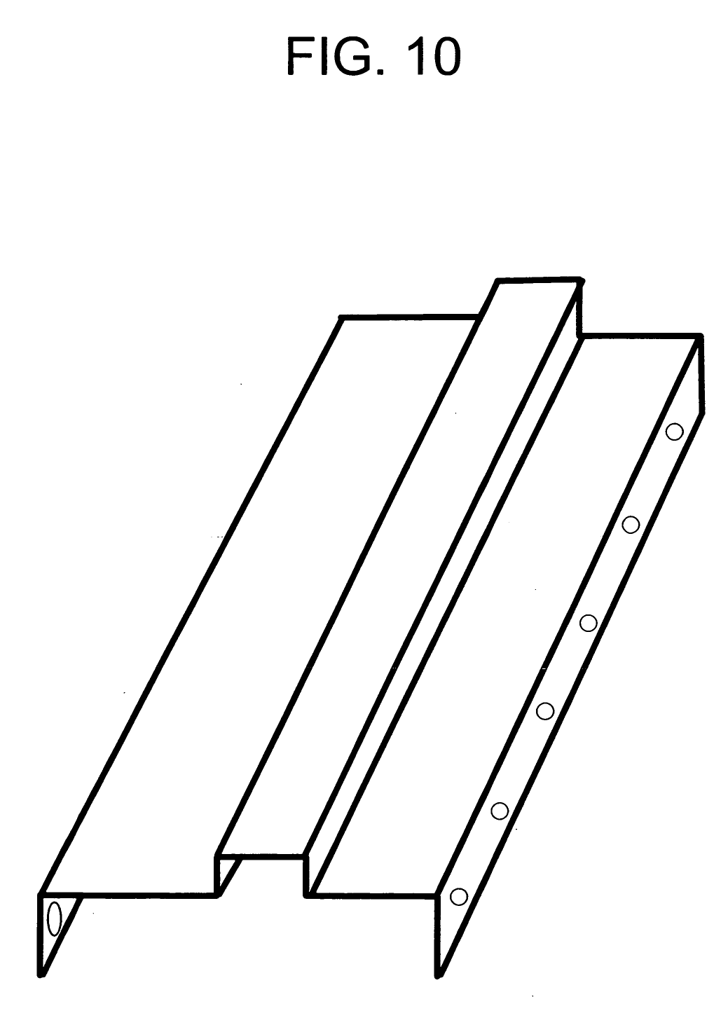

FIG. 8 is another embodiment of the disclosed door and window buck. The buck 80 shown in FIG. 8 is preferably used for masonry applications and fits standard masonry openings. It should be noted that the buck can be reversed during installation to change the depth of the reveal. In this embodiment, both mounting tabs of the buck are mounted to the outside of the wall.

FIG. 9 shows the buck 80 installed in an opening. As shown, the buck 80 is secured to the masonry structure 82 (not shown) using the fixing means 84. The buck is fixed using screws, nails, anchors, and the like. The window is then affixed to the raised portion 86 of the buck 80.

In operation, the aperture is a rough opening formed in the concrete structure. The disclosed buck is used as a form for the concrete, slipped over the structure around the four sides of the opening. In a preferred environment, at least the top and bottom bucks are secured to the structure creating a rough opening sized to match the window. Next, a first side buck is affixed to the structure. The window frame is then installed in the opening and secured to the three bucks already secured to the structure. The window frame is then secured to the fourth unsecured buck. After the unsecured buck is secured to the window, it is then secured to the structure. In this manner, a zero tolerance assembly is created eliminating air and water infiltration. Thus, this buck or slip over flashing, effectively eliminates water and air infiltration, the feeding source for mold.

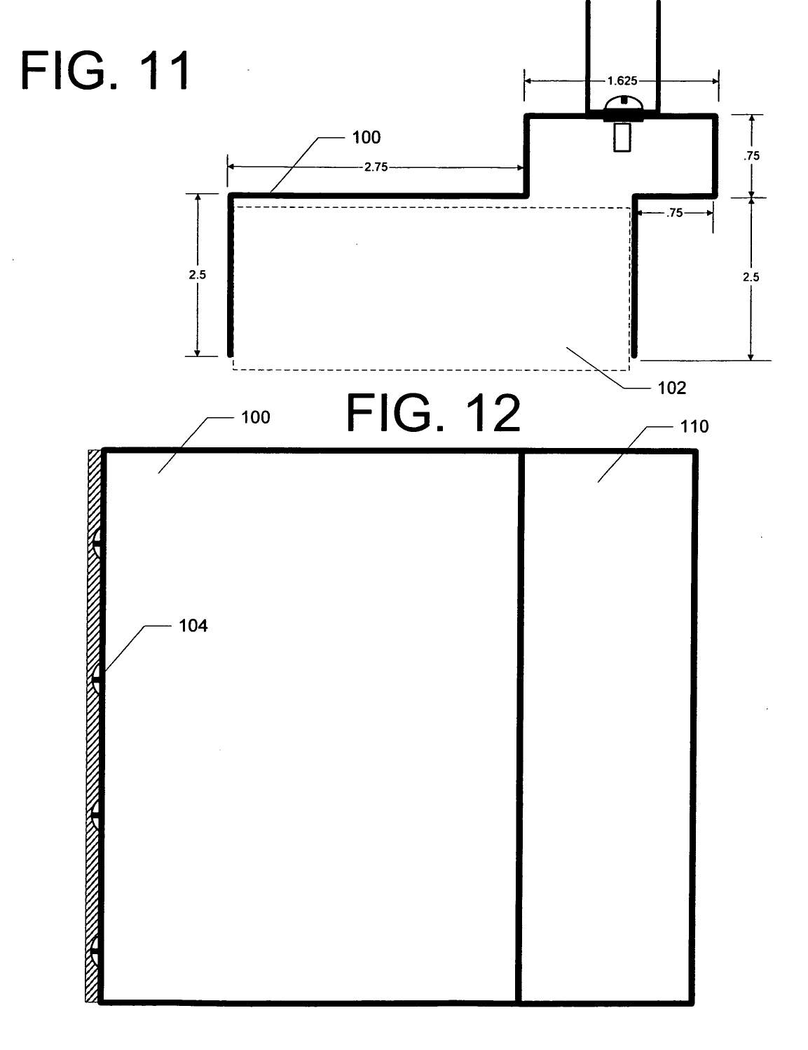

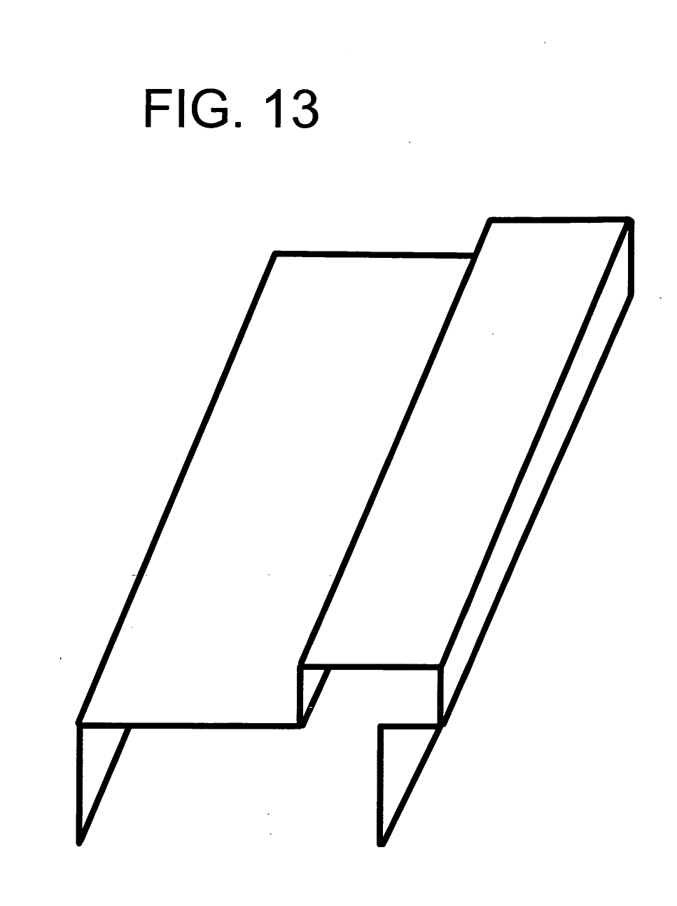

FIG. 11 depicts another embodiment of the invention. The buck 100, shown in FIG. 11, is preferably used for wood frame construction. The buck shown in FIG. 11 eliminates the need for a nail fin on a standard window. As shown, raised portion 110 is offset to accommodate window frames without a nail fin. Thus, window manufacturers need not create a separate window frame for wood frame construction.

FIG. 12 shows the buck 100 installed in an opening. As shown, the buck 100 is secured to the masonry structure 102 (not shown) using the fixing means 104. The buck is fixed using screws, nails, anchors, and the like. The window is then affixed to the raised portion 110 of the buck 100.

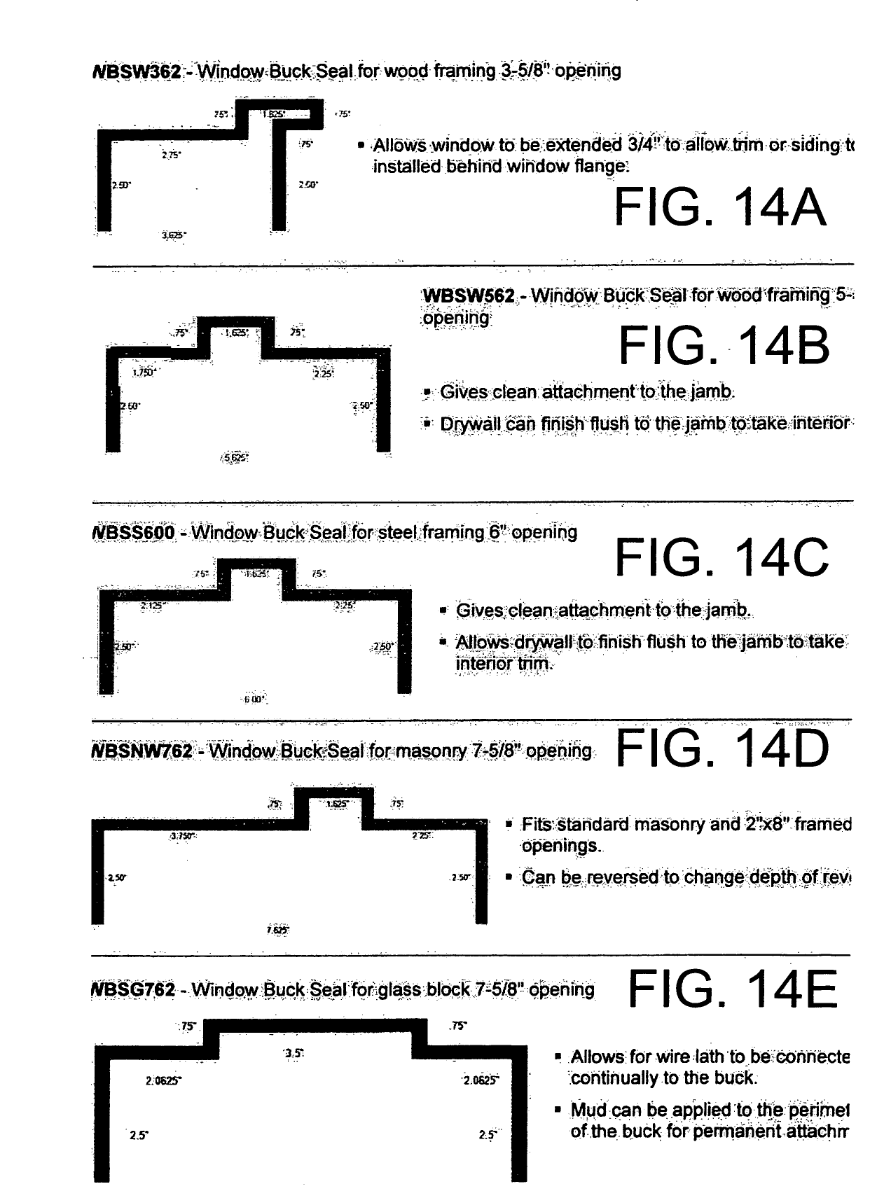

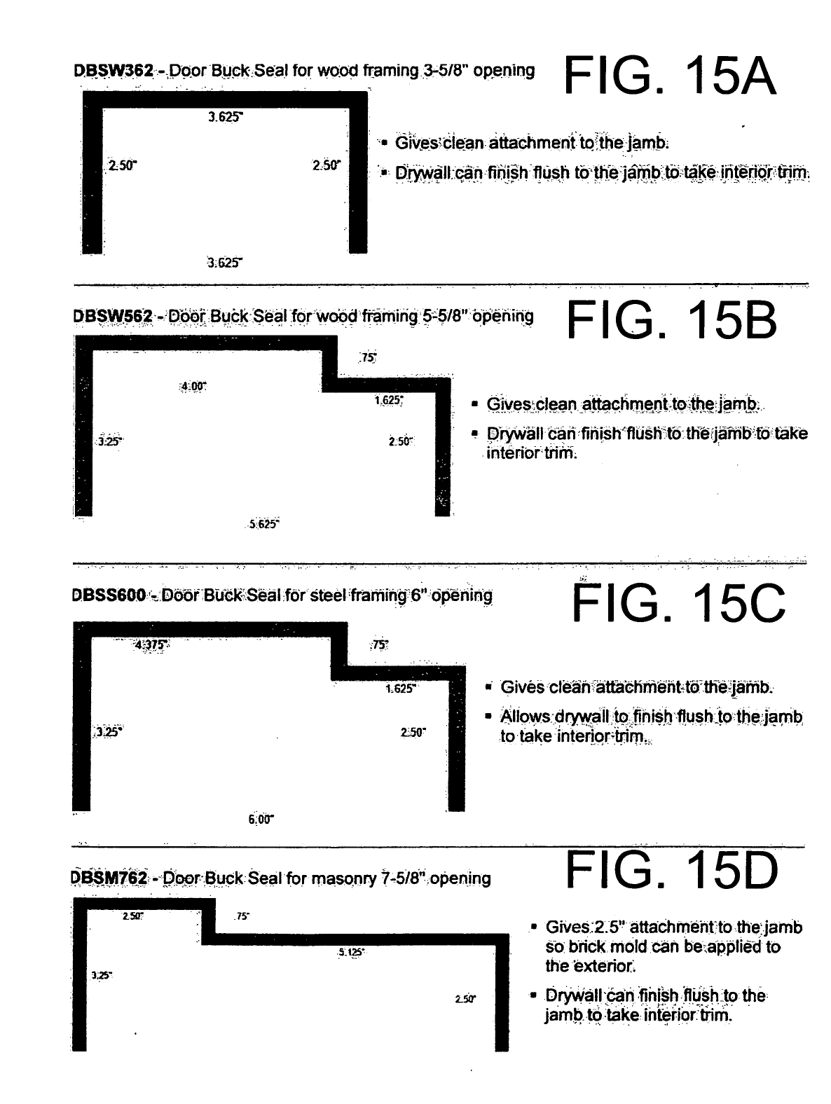

FIG. 14 depicts various window bucks for wood, steel, and masonry construction. FIG. 15 depicts various door bucks for wood, steel, and masonry construction.

The disclosed bucks can be formed using a standard break, roll forming, extrusions, and the like. Likewise, while described for use in wood, masonry, and steel construction with standard frame windows, the disclosed buck can also be used with glass block doors, sliding doors, windows, and the like.

It should be noted that in one embodiment, the four pieces of the buck are placed in the aperture of the structure. At least a first one of the bucks is leveled, squared, and affixed to the structure. Next, the window frame is affixed to the first buck secured to the structure. Next, the remaining bucks are affixed to the window frame then to the structure. It should be noted that using this method, as well as the method discussed above, zero tolerance between the window frame and structure is achieved, thereby eliminating air and water filtration. Additionally, using the described buck, installation is fast and precise allowing builders and installers to accelerate job completion.

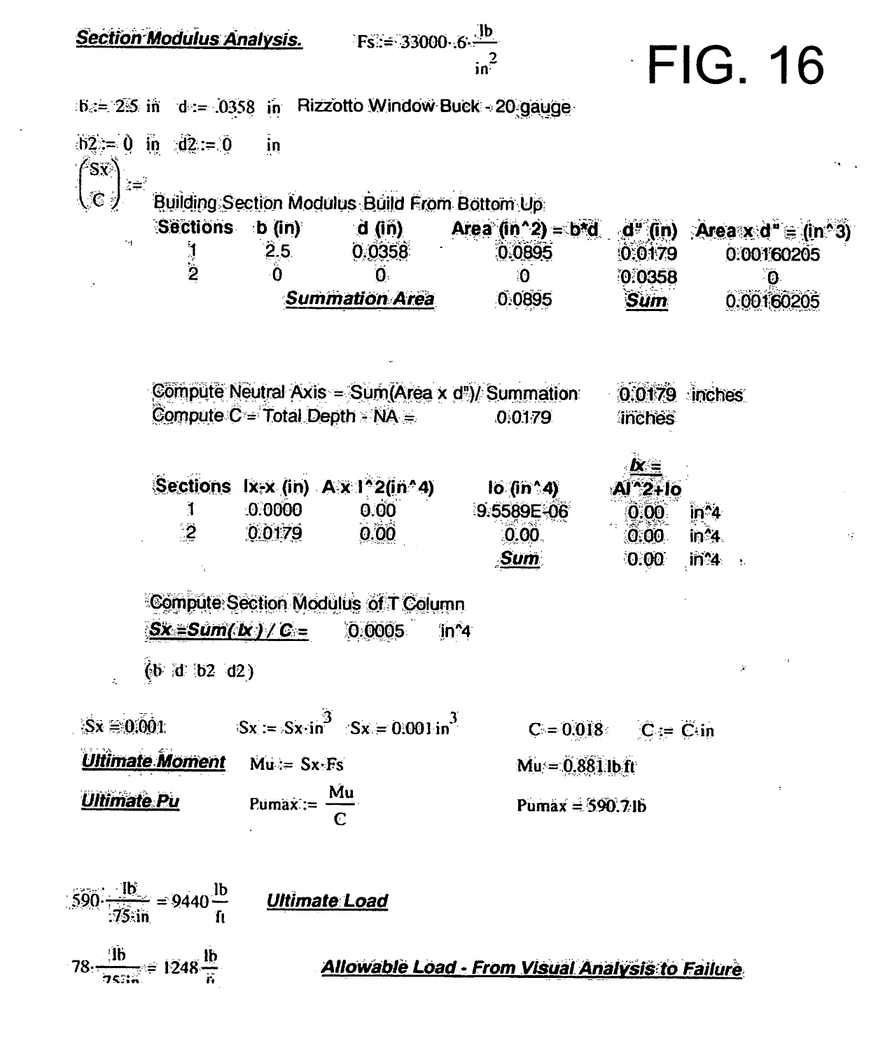

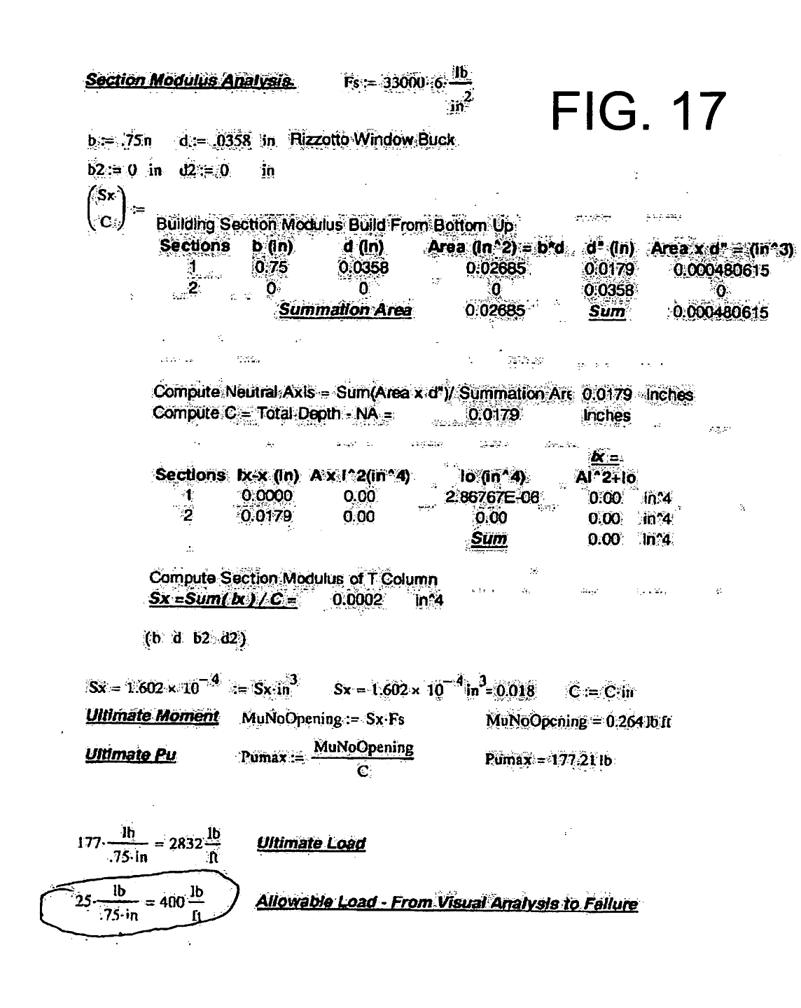

The disclosed buck provides an increased allowable load over prior art bucks. A load analysis for two embodiments of the disclosed buck is shown in FIGS. 16 and 17.

In one embodiment, any of the pockets created between the buck and the structure are filled with an insulating material to improve the installation capacity of the building.

The slip-over flashing for use as a door or window buck described herein comprises a first pair of walls substantially parallel to one another which are used to affix the buck to the structure. At the top end of these two walls there is at least one wall perpendicular to the sidewalls. A second pair of walls substantially parallel to one another and parallel to the first two walls rise above the perpendicular wall. These second two power walls are joined at their tops with a perpendicular wall. This perpendicular wall is used as the window frame mount. The window frame mount can be positioned in various locations to accommodate various window frames and construction techniques as shown in the various environments disclosed herein. However, it should be noted that there are other potential embodiments and not all of the embodiments are disclosed herein.

While this invention has been described by reference to preferred embodiments, it should be understood that numerous changes could be made within the spirit and scope of the inventive concepts described. Accordingly, it is intended that the invention not be limited to the disclosed embodiment, but that it have the full scope permitted by the language of the following claims.

What is claimed is:

1. A frame for an aperture in a wall of a building comprising:
an elongated sheet of material;
the sheet having at least 3 bends of substantially 90 degrees,
the first bend forming a first and second wall, the first wall extending in a first direction from an edge of the sheet to the first bend and the second wall extending in a second direction;
the second bend forming a third wall, the third wall being substantially parallel to the first wall extending in a third direction opposite the first direction;
the third bend forming a forth wall, the forth wall extending in the second direction,
wherein at least the first wall is adapted to mount to a first outside surface of the wall.

2. The frame for an aperture in a wall of a building of claim 1, further comprising:
a forth bend forming a fifth wall, the fifth wall extending in a direction opposite the first direction, wherein
the fifth wall is adapted to mount to a second outside surface of the wall.

3. The frame for an aperture of claim 1, wherein:
the sheet of material is at least 8.75 inches wide.

4. The frame for an aperture of claim 3, wherein:
the first wall is approximately 2.75 inches wide.

5. The frame for an aperture of claim 4, wherein:
the second wall is approximately 4.5 inches wide.

6. The frame for an aperture of claim 5, wherein:
the third wall is approximately 0.75 inches wide.

7. The frame for an aperture of claim 6, wherein:
the forth wall is approximately 0.75 inches wide.

8. The frame for an aperture of claim 7, wherein:
the third wall is approximately 0.75 inches wide.

9. The frame for an aperture of claim 2, wherein:
the sheet of material is approximately 20 gauge metal.

10. The frame for an aperture of claim 7, wherein:
the sheet of material is approximately 20 gauge metal.

11. The frame for an aperture of claim 2, wherein:
the sheet of material is a vinyl or plastic extrusion material.

12. A method of installing a closure a building comprising:
creating an aperture in a wall of the building;
placing at least three bucks about the perimeter of the aperture;
affixing at least a first buck to an outer surface of the wall containing the aperture;
attaching a frame of the closure to the first buck;
attaching the frame of the closure to the remaining bucks; and
affixing the remaining bucks to the outer surface of the wall containing the aperture, wherein
the buck comprises an elongated sheet of material, the sheet having at least 4 bends of substantially 90 degrees, the first bend forming a first and second wall, the first wall extending in a first direction from an edge of the sheet to the first break and the second wall extending in a second direction; the second bend forming a third wall, the third wall being substantially parallel to the first wall extending in a third direction opposite the first direction; the third bend forming a forth wall, the forth wall extending in the second direction, wherein at least the first wall is adapted to mount to an outside surface of the wall.

13. The method of framing an aperture according to claim 12 wherein the buck is affixed to the outer surface of the wall using #8×½ screws.

14. A buck for an aperture in a wall of a building comprising:
an elongated sheet of material;
the sheet having at least 6 bends of substantially 90 degrees,
the first bend forming a first and second wall, the first wall extending in a first direction from an edge of the sheet to the first bend and the second wall extending in a second direction;
the second bend forming a third wall, the third wall being substantially parallel to the first wall extending in the first direction;
the third bend forming a forth wall, the forth wall extending in the second direction,
the forth bend forming a fifth wall, the fifth wall being substantially parallel to the first wall extending in a direction opposite the first direction;
the fifth bend forming a sixth wall, the sixth wall being substantially parallel to the forth wall,
the sixth bend forming a seventh wall, the seventh wall being substantially parallel to the first wall extending in a direction opposite the first direction;
wherein the first and seventh walls are adapted to mount to a first and second outer surface of the wall of the building.

15. The buck of claim 14, wherein:
the sheet of material is approximately 8.75 inches wide.

16. The buck of claim 15, wherein:
the first wall is approximately 2.5 inches.

17. The buck of claim 14, wherein:
the sheet of material is approximately 20 gauge metal.

18. The buck of claim 14, wherein:
the sheet of material is approximately 20 gauge metal.

19. The buck of claim 15, wherein:
the sheet of material is a vinyl or plastic extrusion material.

20. The buck of claim 14, wherein:
the sixth wall extends in the second direction.

21. The buck of claim 14, wherein:
the sixth wall extends in a direction opposite the second direction.

22. A slip-over buck comprising:
a first pair of walls each having a top and bottom edge, the first pair of walls being substantially parallel to one another and adapted to be affixed to a pair of outer surfaces of a wall;
a second pair of walls each having a top and bottom edge, the bottom edge of each of the second pair of walls being connected to a corresponding top edge of the first pair of walls, the second pair of walls being substantially parallel to the first pair of walls; and
a perpendicular wall connecting the top edges of the second pair of walls.

23. The slip-over buck of claim 22, further comprising:
at least one connecting wall for connecting a one of the first pair of walls to a corresponding one of the second pairs of walls, the connecting wall attached between the top edge of the one of the first pair of walls and the bottom edge of the corresponding one of the second pair of walls, the connecting wall being substantially parallel to the perpendicular wall.

24. The slip-over buck of claim 22, further comprising:
a pair of connecting walls for connecting each wall in the first pair of walls to each of the corresponding walls in the second pairs of walls, the connecting walls being attached between the top edge of each wall in the first pair of walls and the bottom edge of the corresponding wall in the second pair of walls, the connecting walls being substantially parallel to the perpendicular wall.

25. A frame for an aperture in a wall of a building comprising:
an elongated sheet of material;
the sheet having at least 3 bends of substantially 90 degrees,
the first bend forming a first and second wall, the first wall extending in a first direction from an edge of the sheet to the first bend and the second wall extending in a second direction;
the second bend forming a third wall, the third wall being substantially parallel to the first wall extending in a third direction opposite the first direction;
the third bend connecting the third wall to a mounting tab,
wherein the first wall is adapted to mount to a first outside surface of the wall and the mounting tab is adapted to mount to a second outside surface of the wall.
